(19) United States
(12) Patent Application Publication
(10) Pub. No.: US 2026/0291561 A1
(43) Pub. Date: Sep. 24, 2026

(54) METHODS AND SYSTEMS FOR CHANNEL STATE INFORMATION REPORTING

(71) Applicant: ZTE CORPORATION, Shenzhen (CN)

(72) Inventors: Shujuan ZHANG, Shenzhen (CN); Jun YANG, Shenzhen (CN); Yijian CHEN, Shenzhen (CN); Hongkang YU, Shenzhen (CN); Yuan SI, Shenzhen (CN)

(21) Appl. No.: 19/475,997

(22) PCT Filed: Apr. 19, 2023
(86) PCT No.: PCT/CN2023/089284

§ 371 Date: Oct. 16, 2025

(51) Int. Cl. H04B 7/0456

(52) U.S. Cl. CPC H04B 7/0456

(57) ABSTRACT

Techniques are described to determine and/or to indicate information related to a precoding matrix. An example wireless communication method includes receiving, by a communication device, a reference signal; determining, by the communication device, a precoding matrix based on a measurement performed on the reference signal; and transmitting, by the communication device to a base station or another communication device, information that indicates the precoding matrix.

### CROSS-REFERENCE TO RELATED APPLICATION

This application is a national stage filing under 35 U.S.C. § 371 of international application number PCT/CN2023/089284 filed Apr. 19, 2023. The contents of these applications are incorporated herein by reference in their entirety.

### TECHNICAL FIELD

This document is directed generally to digital wireless communications.

### BACKGROUND

Mobile telecommunication technologies are moving the world toward an increasingly connected and networked society. In comparison with the existing wireless networks, next generation systems and wireless communication techniques will need to support a much wider range of use-case characteristics and provide a more complex and sophisticated range of access requirements and flexibilities.

Long-Term Evolution (LTE) is a standard for wireless communication for mobile devices and data terminals developed by 3rd Generation Partnership Project (3GPP). LTE Advanced (LTE-A) is a wireless communication standard that enhances the LTE standard. The 5th generation of wireless system, known as 5G, advances the LTE and LTE-A wireless standards and is committed to supporting higher data-rates, large number of connections, ultra-low latency, high reliability and other emerging business needs.

### SUMMARY

Techniques are disclosed for performing reporting for channel state information.

An example wireless communication method includes receiving, by a communication device, a reference signal; determining, by the communication device, a precoding matrix based on a measurement performed on the reference signal, where the precoding matrix includes one or more columns, where a column of the one or more columns includes N elements, where the N elements includes M groups of elements, where N and M are integers that are greater than or equal to one, where each of the M groups of elements includes at least two continuous elements from the N elements, where different groups of the M groups of elements include different elements from the N elements, and where at least two of the M groups of elements are related to each other; and transmitting, by the communication device to a base station or another communication device, information that indicates the precoding matrix.

Another example wireless communication method includes transmitting, by a base station or another communication device, a reference signal to a communication device; and receiving, by the base station or the another communication device, information that indicates a precoding matrix from the communication device, where the precoding matrix corresponds to the reference signal, where the precoding matrix includes one or more columns, where a column of the one or more columns includes N elements, where the N elements includes M groups of elements, where N and M are integers that are greater than or equal to one, where each of the M groups of elements includes at least two continuous elements from the N elements, where different groups of the M groups of elements include different elements from the N elements, and where at least two of the M groups of elements are related to each other.

In some embodiments, the column is a weighted vector of more than one vector, each of the more than one vector corresponds to M sub vectors and M coefficients, and each of the M sub vectors and each of the M coefficients is associated with elements corresponding to one group of the M groups of elements of each vector.

In some embodiments, the M groups of elements is associated with M sub vectors and M coefficients, and each of the M groups of elements corresponds to one sub vector of the M sub vectors and one coefficient of the M coefficients. In some embodiments, the at least two of the M groups of elements are related to each other by having a mathematical relationship between at least two of the M sub vectors. In some embodiments, the at least two of the M groups of elements are related to each other by having a mathematical relationship between at least two of the M coefficients.

In some embodiments, the at least two of the M groups of elements are related to each other by having a mathematical relationship between at least one of the M sub vectors and at least one of the M coefficients. In some embodiments, one sub vector with a first predefined feature from the M sub vectors is determined by a first parameter, and each of one or more remaining sub vectors from the M sub vectors other than the one sub vector is determined by the first parameter and a respective second parameter.

In some embodiments, the more than one vector has a mathematical relationship to each other. In some embodiments, one sub vector with a first predefined feature from the M sub vectors is determined by a first parameter, and a third parameter indicates (1) whether each of one or more remaining sub vectors from the M sub vectors other than the one sub vector is same as the one sub vector, and/or (2) a number of second parameters corresponding to of the one or more remaining sub vectors.

In some embodiments, each of the one or more remaining sub vectors is determined by the first parameter and a respective second parameter in response to the third parameter indicating the number of second parameters corresponding to the one or more remaining sub vectors from the M sub vectors other than the one sub vector being larger than zero and/or indicating at least one of the one or more remaining sub vectors from the M sub vectors other than the one sub vector is different from the one sub vector.

In some embodiments, the information that indicates the precoding matrix includes at least one of the third parameter or a second parameter. In some embodiments, the second parameter and the third parameter are transmitted by the communication device in different channel state information (CSI) parts. In some embodiments, the third parameter is transmitted in a channel state information (CSI) part I, and the second parameter corresponding to the one or more remaining sub vectors from the M sub vectors other than the one sub vector is transmitted in a CSI part II to the base station in response to a condition being satisfied, or the second parameter is not transmitted in the CSI part II in response to the condition not being satisfied.

In some embodiments, the condition includes the third parameter indicating that: at least one of the one or more remaining sub vectors other than the one sub vector is different from the one sub vector with the first predefined feature, and the number of second parameters corresponding to the one or more remaining sub vectors from the M sub vectors other than the one sub vector is greater than zero.

In some embodiments, each of the M sub vectors has only one element with a first value of one and other elements with a second value of zero, and at least two groups of the M groups of elements are related to each other by having a mathematical relationship between positions of the only one element with the first value of one for at least two sub vectors of the M sub vectors. In some embodiments, the at least two sub vectors have continuous indexes among the M sub vectors. In some embodiments, a value for M is determined based on any one or more of: a value of N, a signaling from the base station or the another communication device, or an indication transmitted by the communication device.

In some embodiments, the M groups of elements includes a subset of the N elements. In some embodiments, in a case that M is larger than 1, the N elements is grouped into the M groups of elements. In some embodiments, in a case that M is larger than 1, the N elements is grouped into 2*M groups of elements, and the M groups of elements includes one of following groups: first M groups of the 2*M groups of elements, last M groups of the 2*M groups of elements, groups with odd index among the 2*M groups of elements, or groups with even index among the 2*M groups of elements. In some embodiments, the N elements corresponds to at least N of antenna ports of the reference signal. In some embodiments, the M groups of elements corresponds to a same set of frequency domain vectors, each element of each frequency domain vector corresponds to one frequency domain unit.

In some embodiments, the M groups of elements corresponds to a same weighted vector of multiple frequency domain vectors of the same set of frequency domain vectors. In some embodiments, the M groups of elements corresponds to M sets of sub vectors, each of the M groups of elements is based on a respective set of sub vectors and a set of coefficients, at least two of the M groups of elements have a mathematical relationship to each other includes that at least two sets of sub vectors from the M sets of sub vectors have another mathematical relationship with each other. In some embodiments, the M sets of sub vectors includes a same sub vector.

In some embodiments, all of the M sets of sub vector correspond to same first parameter and at least two of the M set of sub vectors corresponds to a respective second parameter. In some embodiments, the first parameter includes one set of m_{j,u,i} for each j=1,2 and the second parameter including q_{j,i}, the n₁*N_{1,i}+n₂ th element of a sub vector with an index u among sub vectors of a set with index i among the M set of sub vectors has following format:

$${v}_{{n}_{1} * {N}_{1 , i} + {n}_{2} , u , i} = exp ( j 2 π \frac{{m}_{1 , u , i} {O}_{1 , u , i} + {q}_{1 , i}}{{N}_{1 , u , i} {O}_{1 , u , i}} {n}_{1} ) exp ( j 2 π \frac{{m}_{2 , u , i} {O}_{2 , u , i} + {q}_{2 , i}}{{N}_{2 , u , i} {O}_{2 , u , i}} {n}_{2} ) ,$$

$$where$$

$${n}_{1} ∈ \{ 0 , 1 , … , {N}_{1 , i} \} , {m}_{1 , u , i} ∈ \{ 0 , 1 , … , {N}_{1 , i} \} , {q}_{1 , i} ∈ \{ 0 , 1 , … , {O}_{1 , i} - 1 \} ,$$

$${n}_{2} ∈ \{ 0 , 1 , … , {N}_{2 , i} \} , {m}_{2 , u , i} ∈ \{ 0 , 1 , … , {N}_{2 , i} \} , {q}_{2 , i} ∈ \{ 0 , 1 , … , {O}_{2 , i} - 1 \} .$$

In some embodiments, each group of the M groups of elements is a weighted of sub vectors from the respective set of sub vectors corresponding to each group. In some embodiments, the M groups of elements corresponds to a same set of frequency domain vectors, each element of each frequency domain vector corresponds to one frequency domain unit.

In some embodiments, at least two of the M sub vectors have a mathematical relationship to each other, the M coefficients are not correlated to each other and are reported by the communication device, and the M coefficients and the M sub vectors are not correlated to each other.

In some embodiments, at least two of the M sub vectors have a mathematical relationship to each other, at least two of the M coefficients have another mathematical relationship to each other, and the M sub vectors and the M coefficients are not related to each other.

In some embodiments, at least two of the M sub vectors have a mathematical relationship to each other, at least two of the M coefficients have another mathematical relationship to each other, and at least one of the M sub vectors and at least one of the M coefficients are related to each other.

In some embodiments, at least two of the M sub vectors have a mathematical relationship to each other by having a sub vector of the M sub vectors being determined by at least one sub vector that neighbors the sub vector.

In some embodiments, in a case the M groups of elements includes one of following groups: groups with odd index among the 2*M groups of elements, or groups with even index among the 2*M groups of elements, then groups with odd index among the 2*M groups of elements and groups with even index among the 2*M groups of elements corresponds to same M sub vectors, where each of the 2*M groups corresponds to one sub vector and one coefficient. In some embodiments, in a case the M groups of elements includes one of following groups: first M groups of the 2*M groups of elements, or last M groups of the 2*M groups of elements, then the first M groups of the 2*M groups of elements and the last M groups of the 2*M groups of elements corresponds to same M sub vectors, where each of the 2*M groups corresponds to one sub vector and one coefficient.

This patent document describes methods for reporting a precoding matrix. In an example method, a relationship between different groups of multiple groups of each column of the precoding matrix can set up. A technical benefit of the disclosed methods is that it can save overhead of reporting the precoding matrix at least because the relationship is set up. It also can reduce the complexity of searching the precoding matrix (e.g., the codebook) at a user equipment (UE) at least because the relationship is set up. The disclosed methods can also provide a solution for the case that a measurement reference signal is a precoded measurement reference signal. This patent document describes technology that can provide an efficient channel state reporting method for the N in very large systems.

In yet another exemplary aspect, the above-described methods are embodied in the form of processor-executable code and stored in a non-transitory computer-readable storage medium. The code included in the computer readable storage medium when executed by a processor, causes the processor to implement the methods described in this patent document.

In yet another exemplary embodiment, a device that is configured or operable to perform the above-described methods is disclosed.

The above and other aspects and their implementations are described in greater detail in the drawings, the descriptions, and the claims.

### BRIEF DESCRIPTION OF THE DRAWING

FIG. 1A shows an exemplary flowchart for transmitting information related to a precoding matrix.

FIG. 1B shows an exemplary flowchart for receiving information related to a precoding matrix.

FIG. 2 shows an exemplary block diagram of a hardware platform that may be a part of a network device or a communication device.

FIG. 3 shows an example of wireless communication including a base station (BS) (or a user equipment (UE)) and another user equipment (UE) based on some implementations of the disclosed technology.

### DETAILED DESCRIPTION

This patent document describes techniques for determining and/or indicating information related to a precoding matrix. For example, a user equipment (UE) may perform a measurement related to channel state information reference signal for scenarios that may include very large multiple-input multiple-output (MIMO) antenna and determine a precoding matrix based on the measurement.

The example headings for the various sections below are used to facilitate the understanding of the disclosed subject matter and do not limit the scope of the claimed subject matter in any way. Accordingly, one or more features of one example section can be combined with one or more features of another example section. Furthermore, 5G terminology is used for the sake of clarity of explanation, but the techniques disclosed in the present document are not limited to 5G technology only, and may be used in wireless systems that implemented other protocols.

### I. Example Embodiment 1

In a wireless communication system that includes a communication between a user equipment (UE) and a base station or includes a communication between a UE and another UE, the UE receives channel state information-reference signal (CSI-RS) from a base station (or the another UE). The UE determines a precoding matrix based on the measurements performed on the received CSI-RS. Each column of the precoding matrix includes N elements. The N elements may include M groups of elements. Each column may correspond to one layer of R layers. R is equal to or larger than 1. Different groups of the M groups may include different elements from the N elements. Each of the M groups of elements may include at least two continuous elements of the N elements. In some implementation, the N elements just include elements of the M groups of elements. In another implementation, the N elements include elements in M groups of elements and other elements not in any of the M groups. N is equal to or larger than 1. M is equal to or larger than 1.

In some implementation, each column of the precoding matrix is based on a respective first type of vector (that is the vector) which includes N elements. That is the format of each column of the precoding matrix is based on the respective first type of vector. The N elements includes M groups of elements. Each of the M groups of elements is based on one sub vector and one coefficient. Each of the M groups of elements includes continuous elements of the N elements. Different groups of the M groups of elements includes different elements from the N elements. N is one or larger than one. M is equal to or smaller than N. The M groups of elements correspond to M sub vector and M coefficients. At least two groups of the M groups of elements have a mathematical relationship to each other. A sub vector of one group of the M groups includes same number of elements as the corresponding group.

In following description, without further clarification, the M groups of elements can be M groups of the one first type of vector and/or the M groups of one column of the precoding matrix. One column of the precoding matrix can be referred to as a precoding matrix of one layer or a precoding vector of one layer.

In some implementation, the at least two groups of the M groups of elements having a mathematical relationship to each other includes any one or more of:
at least two of the M sub vectors have a mathematical relationship to each other (or are correlated to each other),
at least two of the M coefficient have a mathematical relationship to each other, and.
at least one of the M sub vectors and at least one of M coefficients have a mathematical relationship to each other.

Regarding the M groups of elements having a mathematical relationship to each other, there are following three implementations.
In a first implementation, at least two of the M sub vectors have a mathematical relationship to each other. The M coefficients are not correlated to each other and are reported by the UE respectively. The M coefficients and the M sub vector are not correlated to each other. The UE reports the M coefficients respectively. The UE reports a parameter shared by the M sub vectors or the at least two sub vectors.
In a second implementation, at least two of the M sub vectors have a mathematical relationship to each other. At least two of the M coefficients have a mathematical relationship to each other. The M sub vectors and the M coefficients are not related to each other. The UE reports a parameter shared by the M sub vectors or the at least two sub vectors. The UE reports another parameter shared by the M coefficients or the at least two coefficients of the M coefficients.
In a third implementation, at least two of the M sub vectors have a mathematical relationship to each other. At least two of the M coefficients have a mathematical relationship to each other. At least one of the M sub vector and at least one of the M coefficients are related to each other. The UE reports a parameter shared by the M sub vectors or the at least two sub vectors. The UE reports another parameter shared by the M coefficients or the at least two coefficients of the M coefficients. The parameter and the another parameter may be determined by each other, then the UE only reports one of the parameter and the another parameter, or the UE reports a third parameter used to determine the parameter and the another parameter.

In some implementation, at least two of the M sub vectors having a mathematical relationship to each other can mean that all of the M sub vectors are determined by a same first parameter and the at least one of the M sub vectors is determined by the first parameter and another parameter. For example, one sub vector with a first predefined feature of the M sub vectors is determined by the first parameter. The remaining M−1 sub vector are determined by the first parameter and a respective second parameter. Each of the remaining M−1 sub vectors corresponds to a respective second parameter. In some embodiments, the one sub vector with the first predefined feature is determined by the first parameter. There is a third parameter indicating at least one of whether the remaining M−1 sub vectors is same as the one sub vector with the first predefined feature and the number of the second parameters corresponding to the remaining M−1 sub vectors. If the third parameter indicating at least one of the remaining M−1 sub vector are same as the one sub vector with the first predefined feature and the number of the second parameters corresponding to the remaining M−1 sub vectors being 0, each of the remaining M−1 vector is determined by the first parameter instead of the first parameter and the respective second parameter. If the third parameter indicating at least one of the remaining M−1 sub vector are different from the one sub vector with the first predefined feature and the number of the second parameters corresponding to the remaining M−1 sub vectors being larger than 0, each of the remaining M−1 vector is determined by the first parameter and its respective second parameter. The another parameter includes at least one of the second parameter and the third parameter. In some implementation, the third parameter and the second parameter are reported in different CSI part. For example, the third parameter is reported in CSI part I and the second parameter is reported in CSI part II. The second parameter is reported in CSI part II only if the third parameter indicating at least one of the remaining M−1 are different from the one sub vector with the first predefined feature and the number of second parameter corresponding to the remaining M−1 sub vector is larger than 0. The second parameter is not reported in CSI part II if the third parameter indicating at least one of the remaining M−1 are same as the one sub vector with the first predefined feature and the number of second parameter corresponding to the remaining M−1 sub vector is 0. In some implementation, each of the M sub vectors is determined by a same first parameter and a respective second parameter. The second parameter of the one sub vector with the first predefined feature has a second predefined feature and needs not to be reported by the UE.

In some implementation, the one sub vector with the first predefined feature is with an index 0 among the M sub vectors. In some embodiments, the one sub vector with the first predefined feature is one sub vector corresponding to one group of the M groups whose coefficient with largest amplitude among the M coefficients.

In some implementation, at least two of the M sub vectors having a mathematical relationship to each other can mean that a sub vector of the M sub vectors is determined by at least one its neighboring sub vector. The sub vector and its neighboring sub vector correspond to groups with neighboring indexes among the M groups. For example, the sub vector with index i among the M groups is determined by the sub vector with index i−1 among the M groups.

For example, each group with index i among the M groups has following format

$${W}_{i} = {α}_{i} {V}_{i} , {V}_{i} = [ \begin{matrix}{v}_{0 , i} \\ {v}_{1 , i} \\ ⋮ \\ {v}_{{N}_{i} , i}\end{matrix} ] , i ∈ \{ 0 , 1 … M - 1 \} , \qquad ( 1 )$$

wherein, αᵢ and Vᵢ are the coefficient and the sub vector respectively corresponding to the group with index i among the M groups. For example, v_{n,i} is determined by at least one of the following formula

$${v}_{n , i} = exp ( j 2 π \frac{{m}_{i} {O}_{i} + {q}_{i}}{{N}_{i} {O}_{i}} n ) , n ∈ \{ 0 , 1 , … {N}_{i} - 1 \} , {m}_{i} ∈ \{ 0 , 1 , … {N}_{i} - 1 \} , \qquad ( 2 )$$

$${q}_{i} ∈ \{ 0 , 1 … {O}_{i} - 1 \} ;$$

$${v}_{n , i} = exp ( j 2 π \frac{{m}_{i} {O}_{i} + {q}_{i}}{{N}_{i} {O}_{i}} n + {b}_{i} {n}^{2} ) , n ∈ \{ 0 , 1 , … {N}_{i} - 1 \} , \qquad ( 3 )$$

$${m}_{i} ∈ \{ 0 , 1 , … {N}_{i} - 1 \} , {q}_{i} ∈ \{ 0 , 1 … {O}_{i} - 1 \} ;$$

$${V}_{i} = {V}_{1 , i} ⊗ {V}_{2 , i} = [ \begin{matrix}{v}_{2 , 0 , i} {V}_{1 , i} \\ {v}_{2 , 1 , i} {V}_{1 , i} \\ ⋮ \\ {v}_{2 , {N}_{2 , i} , i} {V}_{1 , i}\end{matrix} ] , wherein$$

$${v}_{j , {n}_{j} , i} = exp ( j 2 π \frac{{m}_{j , i} {O}_{j , i} + {q}_{j , i}}{{N}_{j , i} {O}_{j , i}} {n}_{j} ) , {n}_{j} ∈ \{ 0 , 1 , … {N}_{j , i} - 1 \} ,$$

$${m}_{j , i} ∈ \{ 0 , 1 , … {N}_{j , i} - 1 \} , {q}_{j , i} ∈ \{ 0 , 1 … {O}_{j , i} - 1 \}$$

$$j = 1 , \qquad ( 4 )$$

$$2 {v}_{j , n , i} is the value of element with index {n}_{j} among {N}_{j , i} elements of {V}_{j , i} ;$$

$${v}_{{n}_{1} * {N}_{1 , i} + {n}_{2} , i} = exp ( j 2 π \frac{{m}_{1 , i} {O}_{1 , i} + {q}_{1 , i}}{{N}_{1 , i} {O}_{1 , i}} {n}_{1} ) * exp ( j 2 π \frac{{m}_{2 , i} {O}_{2 , i} + {q}_{2 , i}}{{N}_{2 , i} {O}_{2 , i}} {n}_{2} ) , \qquad ( 5 )$$

$$wherein$$

$${n}_{1} ∈ \{ 0 , 1 , … {N}_{1 , i} - 1 \} , {m}_{1 , i} ∈ \{ 0 , 1 , … {N}_{1 , i} - 1 \} , {q}_{1 , i} ∈ \{ 0 , 1 … {O}_{1 , i} - 1 \}$$

$$and$$

$${n}_{2} ∈ \{ 0 , 1 , … {N}_{2 , i} , - 1 \} , {m}_{2 , i} ∈ \{ 0 , 1 , … {N}_{2 , i} - 1 \} , {q}_{2 , i} ∈ \{ 0 , 1 … {O}_{2 , i} - 1 \} ; or$$

$${V}_{i} = {E}_{{n}_{i}} \qquad ( 6 )$$

mᵢ,qᵢ is determined by m,q which is shared by the M sub vectors, that is the same first parameter includes m,q. One sub vector with the first predefined feature is determined by m, q. For example, the index of the one sub vector with the first predefined feature is i₀. The remaining M sub vectors are determined by at least one of following method:
Method 1: mᵢ=m+Δ_{1,i},qᵢ=q+Δ_{2,i}, i≠i₀,i∈{0,1, . . . M−1}, wherein the second parameter includes the Δ_{1,i},Δ_{2,i};
Method 2, mᵢ=mᵢ₋₁+Δ_{1,i},qᵢ=qᵢ₋₁+Δ_{2,i},i∈{1, . . . . M−1}, m₀=m, q₀=q,
Method 3, mᵢ=m_{1,i},qᵢ=q+Δ_{2,i},i∈{0,1, . . . . M−1} and Δ_{1,i}_{₀},Δ_{2,i}_{₀} satisfies a third feature and not reported by the UE. For example, Δ_{1,i}_{₀}=0,Δ_{2,i}_{₀}=0.
Method 4, mᵢOᵢ+qᵢ=mO+q+Δ_{3,i},i∈{0,1, . . . . M−1}. Δ_{3,i}_{₀} satisfies a third feature. For example, Δ_{3,i}_{₀}=0.
Method 5, mᵢOᵢ+qᵢ=mO+q+Δ_{3,i},i∈{0,1, . . . M−1}.
Method 6, mᵢOᵢ+qᵢ=mᵢ₋₁Oᵢ₋₁+qᵢ₋₁+Δ_{3,i},i∈{1, . . . . M−1}.

In some implementation, the M sub vectors is based on a same value of b. The M of bᵢ can be same if formula (2) is adopted.

In some embodiments, the M of bᵢ can be determined by a same first parameter (such as same b) and a respective Δ_{4,i}. For example, bᵢ=b+Δ_{4,i},i∈{0,1, . . . . M−1} The second parameter includes Δ_{4,i}.

In the case where the v_{n,i} is determined by at least one of formula (4) and (5), the number of elements in the group with index i is Nᵢ=N_{1,i}*N_{2,i}. m_{j,i},q_{j,i},j∈{1,2} is determined by mⱼ,qⱼ,j∈{1,2} which is shared by the M sub vector of V_{j,i},j=1,2,i∈{0,1, . . . . M−1}. One sub vector with the first predefined feature is determined by mⱼ,qⱼ,j∈{1,2}. For example, the index of one sub vector with the predefined feature is i₀. The remaining M sub vectors are determined by at least one of method:

Method 1, m_{j,i}=mⱼ+Δ_{j,1,i}+q_{j,i}=qⱼ+Δ_{j,2,i},i≠i₀,i∈{0,1, . . . M−1}, j∈{1,2}.

Method 2, m_{j,i}=m_{j,i+1}+Δ_{j,l,i},q_{j,i}=q_{j,i-1}+Δ_{j,2,i},i∈{1, . . . . M−1}, j∈{1,2}.

Method 3, m_{j,i}=mⱼ+Δ_{j,l,i},q_{j,i}=qⱼ+Δj_{j,2,i}i∈{0,1, . . . . M−1}, j∈{1,2} and Δ_{j,1,i}_{_{0,j}},Δ_{j,2,j}_{_{0,j}} satisfies a third feature. For example, Δ_{j,1,i}_{_{0,j}}=0,Δ_{j,2,i}_{_{0,j}}=0.

Method 4, m_{j,i}Oᵢ+q_{j,i}=m_{j,i-1}O_{j,i-1}+q_{j,i-1}+Δ_{j,3,i},i∈{0,1, . . . . M−1}, j∈{1,2} Δ_{j,3,i}_{_{0,j}} satisfies a third feature and is not reported by the UE. For example, Δ_{j,3,i}_{_{0,j}}=0.

Method 5, m_{j,i}O_{j,i}+q_{j,i}=mⱼO_{j,i}+qⱼ+Δ_{j,3,i}, i≠i₀, i∈{0,1, . . . M−1}, j∈{1,2}.

Method 6, m_{j,i}O_{j,i}+q_{j,i}=m_{j,i-1}O_{j,i-1}+_{q,j,i-1}+Δ_{j,3,i},i∈{1, . . . . M−1}, j∈{1,2}.

In some implementation, the relationship between the M of the V_{1,i} and the relationship among M of the V_{2,i} is reported/determined based on respective parameter, such as Δ_{j,1,i},Δ_{j,2,i},Δ_{j,3,i} is reported/determined for each j, j=1,2. For example, the M of the V_{1,i} are same based on a signaling from a base station (or the another UE) or a rule. The rule includes that N_{1,i} or N₁ is smaller than or equals to a threshold. N₁*N₂=N. The UE reports V_{2,i} using the relationship among M of the V_{2,i} and the UE reports/determines V_{1,i} not using the above relationship among M of the V_{1,i}. In another implementation, the UE respectively reports V_{1,i} using the relationship between the M of the V_{1,i} and reports V_{2,i} using the relationship among M of the V_{2,j}. In some implementation, the V_{1,i} and reports V_{2,i} respectively correspond to a horizontal spatial domain vector and a vertical spatial domain vector.

In the case where the v_{n,i} is determined by formula (6), each of M sub vectors is a vector with only one element being 1 and the other remaining elements being 0. That is Eₙ_{ᵢ} includes Nᵢ elements and only the element with index n among the Nᵢ elements is 1 and the remaining Nᵢ−1 elements is 0. The positions of an elements with value 1 of the M sub vectors have a mathematical relationship to each other. For example, the positions of an element that have a value 1 of each of the M sub vectors are based on a same first parameter. In some embodiments, the position of an elements that have a value 1 of a sub vector of the M sub vectors is based on the position of an element with value 1 of its neighboring sub vector of the M sub vectors. For example, the index of the element with value 1 of a group with index i among the M groups is determined by at least one of formula:
nᵢ=n+Δᵢ,i∈{0,1, . . . . M−1}, nᵢ, n∈{0,1, . . . . Nᵢ−1}. Δᵢ ∈{−C₁+1, . . . ,0,1, . . . . C₂−1}.
nᵢ=mod (n+Δᵢ,Nᵢ),i∈{0,1, . . . . M−1}, nᵢ,n∈{0,1, . . . Nᵢ−1}, Δᵢ∈{0,1, . . . . C−1}.
nᵢ=nᵢ₋₁+Δ,i∈{0,1, . . . . M−1}, nᵢ∈{0,1, . . . . Nᵢ−1}. Δᵢ∈{−C₁+1, . . . ,0,1, . . . C₂−1}
nᵢ=mod (nᵢ₋₁+Δᵢ,Nᵢ), i∈{0,1, . . . . M−1},nᵢ∈{0,1, . . . . Nᵢ−1}, Δᵢ∈{0,1, . . . . C−1}.

At least one of C₁, C₂, and C are determined by at least one of a rule, a signaling from a base station (or the another UE), and a parameter reported by the UE. The rule includes that C₁, C₂ and C are smaller than or equals to Nᵢ. The UE only reports the value of nᵢ_{₀} which is the position of an element with value 1 of a sub vector with the first predefined feature. The remaining nᵢ is determined by nᵢ_{₀} and above formula. For example, the UE reports the nᵢ_{₀} using ┌log₂ Nᵢ┐ bits, but the UE reports Δᵢ using a number of bits smaller than ┌log₂ Nᵢ┐.

In some implementation, in the case where the v_{n,i} is determined by formula (6), the base station or another UE transmits the measurement reference signal to the UE using a precoding matrix. For example, the base station or the another UE transmits the Nᵢ ports of one group using N orthogonal precoding vectors and the base station or the another UE transmits the n th port of the Nᵢ ports of the group using a orthogonal precoding vector with index n among the Nᵢ orthogonal precoding vectors.

In some implementation, at least two of the M coefficient have a mathematical relationship to each other. For example, the αᵢ is determined by one of the following formula in the case that the v_{n,i} is determined by at least one of the formula (2) and formula (3).

$${α}_{i} = {f}_{1} ( {α}_{i - 1} , {m}_{i - 1} , {q}_{i - 1} , {O}_{i - 1} , {N}_{i - 1} ) , i ∈ \{ 1 , 2 , … M - 1 \} ; \qquad ( 7 )$$

$${α}_{i} = {f}_{2} ( {α}_{i - 1} , {m}_{i - 1} , {q}_{i - 1} , {O}_{i - 1} , {N}_{i - 1} , {m}_{i} , {q}_{i} , {O}_{i} , {N}_{i} ) , i ∈ \{ 1 , 2 , … M - 1 \} ; \qquad ( 8 )$$

$${α}_{i} = {f}_{3} ( {α}_{i - 1} , {m}_{i - 1} , {q}_{i - 1} , {O}_{i - 1} , {N}_{i - 1} , {θ}_{i} ) , i ∈ \{ 1 , 2 , … M - 1 \} ; or \qquad ( 9 )$$

$$( 10 )$$

$${α}_{i} = {f}_{4} ( {α}_{i - 1} , {m}_{i - 1} , {q}_{i - 1} , {O}_{i - 1} , {N}_{i - 1} , {m}_{i} , {q}_{i} , {O}_{i} , {N}_{i} , {θ}_{i} ) , i ∈ \{ 1 , 2 , … M - 1 \}$$

wherein fⱼ(·), j∈{1,2,3,4} are function.

At least one of the M coefficients and at least one of the M sub vector have a mathematical relationship to each other in this case.

For example, the αᵢ is determined by one of the following formula:

$${α}_{i} = {α}_{i - 1} exp ( j 2 π \frac{{m}_{i - 1} {O}_{i - 1} + {q}_{i - 1}}{{N}_{i - 1} {O}_{i - 1}} ( {N}_{i - 1} ) ) \qquad ( 11 )$$

$$( 12 )$$

$${α}_{i} = {α}_{i - 1} exp ( j 2 π \frac{{m}_{i - 1} {O}_{i - 1} + {q}_{i - 1}}{{N}_{i - 1} {O}_{i - 1}} ( {N}_{i} - 1 ) ) exp ( j π ( \frac{{m}_{i - 1} {O}_{i - 1} + {q}_{i - 1}}{{N}_{i - 1} {O}_{i - 1}} + \frac{{m}_{i} {O}_{i} + {q}_{i}}{{N}_{i} {O}_{i}} ) )$$

$${α}_{i} = {α}_{i - 1} exp ( j 2 π \frac{{m}_{i - 1} {O}_{i - 1} + {q}_{i - 1}}{{N}_{i - 1} {O}_{i - 1}} ( {N}_{i} ) ) exp ( j {θ}_{i} ) \qquad ( 13 )$$

$$( 14 )$$

$${α}_{i} = {α}_{i - 1} exp ( j 2 π \frac{{m}_{i - 1} {O}_{i - 1} + {q}_{i - 1}}{{N}_{i - 1} {O}_{i - 1}} ( {N}_{i} - 1 ) ) exp ( j π ( \frac{{m}_{i - 1} {O}_{i - 1} + {q}_{i - 1}}{{N}_{i - 1} {O}_{i - 1}} + \frac{{m}_{i} {O}_{i} + {q}_{i}}{{N}_{i} {O}_{i}} ) ) exp ( j {θ}_{i} )$$

In some implementation, α₀=1.

In some implementation, the UE reports do, the remaining α₀, αᵢ, i={1,2 . . . . M−1} is determined by at least one formula (11) to (12). The UE doesn't report the remaining αᵢ,i∈{1,2 . . . . M−1}.

In some implementation, the UE reports α₀ and θᵢ,i∈{1, 2, . . . . M−1}. The remaining αᵢ,i∈{1,2 . . . . M−1} is determined by at least one above formula (13) to (14).

In the case where the v_{n,i} is determined by at least one of the formula (4) and formula (5), the αᵢ, i∈∈{1,2 . . . . M−1} can be based on at least one of same formula (7) to (14) except for the mᵢ,Oᵢ,Nᵢ,qᵢ,bᵢαᵢ are replaced with m_{j,i},O_{j,i},N_{j,i},q_{j,i},b_{j,i},j∈{1,2}, α_{j,i} respectively and the UE respective determine α_{j,i} respectively. In some implementation, each group with index i among the M groups has following format, Wᵢ=(α_{1,i}V_{1,i})⊗(α_{2,i}V_{2,i})=α_{i,j}*α_{2,i}(V_{1,i}⊗V_{2,i}). That is αᵢ=α_{1,i}*α_{2,i}.

In the case where the v_{n,i} is determined by the formula (6), the αᵢ is determined by one of the following formula,

$${α}_{i} = {f}_{5} ( {α}_{i - 1} , {n}_{i - 1} ) , i ∈ \{ 1 , 2 , … M - 1 \} ; \qquad ( 15 )$$

wherein f₅(·) is a function.

For example, the αᵢ is determined by one of the following formula

$${α}_{i} = {α}_{i - 1} exp ( j 2 π ( {n}_{i - 1} {Δ}_{5 , i - 1} ) {N}_{i - 1} ) , \qquad ( 16 )$$

$${α}_{i} = {α}_{i - 1} exp ( j 2 π ( {n}_{i - 1} {Δ}_{5 , i - 1} ) ( {N}_{i - 1} - 1 ) ) exp ( j π ( {n}_{i - 1} {Δ}_{5 , i - 1} + {n}_{i} {Δ}_{5 , i} ) ) \qquad ( 17 )$$

$${α}_{i} = {α}_{i - 1} exp ( j 2 π ( {n}_{i - 1} {Δ}_{5 , i - 1} ) {N}_{i - 1} ) exp ( j {θ}_{i} ) , \qquad ( 18 )$$

$$( 19 )$$

$${α}_{i} = {α}_{i - 1} exp ( j 2 π ( {n}_{i - 1} {Δ}_{5 , i - 1} ) ( {N}_{i - 1} - 1 ) ) exp ( j π ( {n}_{i - 1} {Δ}_{5 , i - 1} + {n}_{i} {Δ}_{5 , i} ) ) exp ( j {θ}_{i} ) ,$$

$${α}_{i} = {α}_{i - 1} exp ( j 2 π ( {n}_{i - 1} {Δ}_{5 , i - 1} + {Δ}_{6 , i - 1} ) {N}_{i - 1} ) , \qquad ( 20 )$$

$$( 21 )$$

$${α}_{i} = {α}_{i - 1} exp ( j 2 π ( {n}_{i - 1} {Δ}_{5 , i - 1} + {Δ}_{6 , i - 1} ) ( {N}_{i - 1} - 1 ) ) exp ( j π ( {n}_{i - 1} {Δ}_{5 , i - 1} + {n}_{i} {Δ}_{5 , i} + {Δ}_{6 , i - 1} + {Δ}_{6 , i} ) ) ,$$

$${α}_{i} = {α}_{i - 1} exp ( j 2 π ( {n}_{i - 1} {Δ}_{5 , i - 1} + {Δ}_{6 , i - 1} ) {N}_{i - 1} ) exp ( j {θ}_{i} ) , \qquad ( 22 )$$

$$( 23 )$$

$${α}_{i} = {α}_{i - 1} exp ( j 2 π ( {n}_{i - 1} {Δ}_{5 , i - 1} + {Δ}_{6 , i - 1} ) ( {N}_{i - 1} - 1 ) ) exp ( j π ( {n}_{i - 1} {Δ}_{5 , i - 1} + {n}_{i} {Δ}_{5 , i} + {Δ}_{6 , i - 1} + {Δ}_{6 , i} ) ) exp ( j {θ}_{i} ) ,$$

wherein 0≤Δ_{5,i}<1,0≤NᵢΔ_{6,i}<1, i∈{0,1, . . . . M−1}. Δ_{5,i}Δ_{6,i} is determined by at least one of a signaling from a base station (or the another UE), information reported by the UE and a rule.

The formula (20)-(23) can provide more accurate precoding matrix. In some embodiments, Δ_{5,i}=1,Δ_{6,i}=0, or Δ_{5,i}=1/Nᵢ,Δ_{6,i}=0.

In some implementation, the at least one of the M sub vectors and at least one of M coefficients have a mathematical relationship to each other. For example, at least one of mᵢ₋₁,qᵢ₋₁ is depend on the αᵢ and αᵢ₊₁ in the case that the v_{n,i} is determined by one of formula (2) or (3). For example,

$$\frac{{m}_{i - 1} {O}_{i - 1} + {q}_{i - 1}}{{N}_{i - 1} {O}_{i - 1}} = ang ( \frac{{α}_{i}}{{α}_{i - 1}} ) / ( {N}_{i - 1} * 2 π ) \qquad ( 23 )$$

$${n}_{i} = ang ( \frac{{α}_{i}}{{α}_{i - 1}} ) / ( {N}_{i} * 2 π * {Δ}_{5 , i} ) \qquad ( 24 )$$

In some implementation, the UE reports a vector including M elements each of which is one of the M coefficients αᵢ,i∈{0,1, . . . . M−1} using a vector quantified method. For example

$$A = [ \begin{matrix}{α}_{0} \\ {α}_{1} \\ ⋮ \\ {α}_{M - 1}\end{matrix} ] = {\sum }_{k =}^{K - 1} {A}_{i} , \qquad ( 25 )$$

wherein Aᵢ is a vector with M elements. K is equal to or larger than 1.

In some implementation, the M is determined by at least one of N, a signaling from base station (or the another UE), an indication reported by the UE. For example, the larger the N, the larger the M.

In a first implementation, the M groups of elements includes the N elements. That is the M groups of elements includes all of the N elements. The N is equals to the sum of numbers of the M groups.

In a second implementation, the M groups of elements includes partial of the N elements. For example, the N elements includes 2M groups of elements. The M groups elements is the first M groups of the 2M groups or the last M groups of the 2M groups. In some implementation, only the first M groups of the 2M groups satisfies above mathematical relationship to each other feature. In some implementation, only the last M groups of the 2M groups satisfy above mathematical relationship to each other feature. In some implementation, the first M groups of the 2M groups satisfy above mathematical relationship to each other feature and the last M groups of the 2M groups also satisfy above mathematical relationship to each other feature. They satisfy above mathematical relationship to each other feature respectively. For example, the N elements includes 4 groups. The M groups can be group 0 and group 1. In some embodiments, the M groups can be group 2 and group 3. In some implementation, further the group 0 and the group 2 have same sub vector and have respective coefficient. And the group 1 and the group 3 have same sub vector and have respective coefficient. For example, the first type of vector has following format

$${W}^{1} = [ \begin{matrix}{α}_{0} {V}_{0} \\ {α}_{1} {V}_{1} \\ {α}_{2} {V}_{0} \\ {α}_{3} {V}_{1}\end{matrix} ] \qquad ( 26 )$$

W₀=α₀V₀ and W₁=α₁V₁. Alternative, W₀=α₂V₀ and W₁=α₃V₁.

In a third implementation, the M groups of elements includes partial of the N elements. The M groups are the M groups with odd index of the 2M groups or the M groups are M groups with even index of the 2M groups. In some implementation, only the M groups with odd index among the 2M groups satisfy above mathematical relationship to each other feature. In some implementation, only the M groups with even index among the 2M groups satisfy above mathematical relationship to each other feature. In some implementation, the M groups with odd index among the 2M groups satisfy above mathematical relationship to each other feature and the M groups with even index among the 2M groups also satisfy above mathematical relationship to each other feature. They satisfy above mathematical relationship to each other feature separately. For example, the N elements includes 4 groups. The M groups can be group 0 and group 2. In some embodiments, the M groups can be group 1 and group 3. In some implementation, further, the group 0 can the group 1 have same sub vector and have respective coefficient, and the group 2 can the group 3 have same sub vector and have respective coefficient.

For example, the first type of vector has following format

$${W}^{1} = [ \begin{matrix}{α}_{0} {V}_{0} \\ {α}_{1} {V}_{0} \\ {α}_{2} {V}_{1} \\ {α}_{3} {V}_{1}\end{matrix} ] \qquad ( 27 )$$

W₀=α₀V₀ and W₁=α₂V₁. Alternative, W₀=α₁V₀ and W₁=α₃V₁.

In some implementation, the number of elements for different groups are same, then the subscript i of Nᵢ,Oᵢ can be ignored.

In some implementation, the first type of vector corresponds to one layer of R layers. For example, for calculating the CQI (Channel quantity indicator), the UE assumes one of following transmission scheme

$${Y}_{i} ( s ) = {\sum }_{l = 0}^{R - 1} {W}_{i , l} {x}_{l} ( s ) , l = 0 , 1 … R - 1 \qquad ( 28 )$$

$${Y}_{i} ( s ) = \frac{1}{{γ}_{l}} {{\sum }_{l = 0}}^{R - 1} {W}_{i , l} {x}_{l} ( s ) , l = 0 , 1 … R - 1 \qquad ( 29 )$$

$${Y}_{i} ( s ) = [ \begin{matrix}{\sum }_{l = 0}^{R - 1} {W}_{i , l}^{A} {x}_{l} ( s ) \\ {\sum }_{l = 0}^{R - 1} {W}_{i , l}^{B} {x}_{l} ( s )\end{matrix} ] , l = 0 , 1 … R - 1 \qquad ( 30 )$$

$$Y ( s ) = {\sum }_{l = 0}^{R - 1} {W}_{l}^{1} {x}_{l} ( s ) , l = 0 , 1 … R - 1 \qquad ( 31 )$$

wherein the Yᵢ(s) correspond to N, CSI-RS antenna ports of one group with index i of the M groups on a time frequency resource with index s and W_{i,l} correspond to the elements of the one group with index i among the M groups of the N elements of a first type of vector of layer l. The Y(s) correspond to N CSI-RS antenna ports of the R first type of vectors. Each layer has its respective first type of vector W_{i,l}. xₗ(s) is the lth layer of PDSCH on a time frequency resource with an index s. The M groups of elements of one first type of vector of one layer corresponds to data of the one layer. The one layer is shared by the M groups and all elements of the one first type of vector of the one layer. For example, the one layer is mapped to each elements of the first type of vector of the one layer as shown in formula (28), (29) or (30). One layer data xₗ(s) is mapped to all elements of the first type of vector of the layer l.

$${W}_{i , j}^{A}$$

correspond to the elements of the one group with index i among a first M groups of the N elements of a first type of vector of layer l.

$${W}_{i , j}^{B}$$

correspond to the elements of the one group with index i among a second M groups of the N elements of a first type of vector of layer l. We name the first M groups is M groups A and the second M groups is M groups B. The first M groups have a mathematical relationship to each other as described above. The second M groups have a mathematical relationship to each other. The first M groups includes the first M groups of 2M groups of one first type of vector of one layer. The second M groups includes the last M groups of 2M groups of one first type of vector of the one layer. In some embodiments, the first M groups includes the M groups each of which with odd index among 2M groups of one first type of vector of one layer. The second M groups includes the M groups with even index among 2M groups of one first type of vector of the one layer. Further, the M groups A and the M groups B corresponds to same M sub vectors and its respectively M coefficients. For example, the W_{i,l},

$${W}_{i , l}^{A} , and {W}_{i , l}^{B}$$

are based on the format as shown in formula (1).

$${W}_{l}^{1}$$

is one first type of vector of layer l and can be based on the format as shown in formula (28) to formula (30).

In formula (28)-(31), the precoding matrix includes R columns and each column respectively corresponds to one first type of vector, or is one first type of vector, or is one first type of vector with a coefficient as shown in formula (32-1).

$$Y ( s ) = {\sum }_{l = 0}^{R - 1} \frac{1}{{γ}_{l}} {W}_{l}^{1} {x}_{l} ( s ) , l = 0 , 1 … R - 1 \qquad ( 32 - 1 )$$

That is the precoding vector of layer l is

$${P}_{l} = \frac{1}{{γ}_{l}} {W}_{l}^{1} \qquad ( 32 - 2 )$$

In some implementation, γₗ is determined by one of following formula

$${γ}_{l} = \sqrt{{\sum }_{n = 0}^{N - 1} {W}_{l}^{1} ( n ) * {( {W}_{l}^{1} ( n ) )}^{*}} \qquad ( 33 )$$

$${γ}_{l} = N * \sqrt{{\sum }_{n = 0}^{N - 1} {α}_{l , i} ( {α}_{l , i} )} , i ∈ \{ 0 , 1 , … M - 1 \} , or \\ i ∈ \{ 0 , 1 , … 2 * M - 1 \} , l ∈ \{ 0 , 1 , … , R - 1 \} \qquad ( 34 )$$

wherein (x)* means conjugate of x. α_{l,i} is a coefficient of a sub vector with index i among 2M sub vectors of one first type of vector of layer l, or among M sub vectors of one first type of vector of layer l.

In another implementation, the precoding matrix includes R columns and each column is a weighted vector of multiple first type of vectors as shown in formula (35) or (36)

$$Y ( s ) = {\sum }_{l = 0}^{R - 1} ( {\sum }_{j = 0}^{L - 1} {β}_{l , j} {W}_{l , j}^{1} {x}_{l} ( s ) ) , l = 0 , 1 … R - 1 \qquad ( 35 )$$

$$Y ( s ) = {\sum }_{l = 0}^{R - 1} ( {\sum }_{j = 0}^{L - 1} {β}_{l , j} {W}_{l}^{1} {x}_{l} ( s ) ) , l = 0 , 1 … R - 1 \qquad ( 36 )$$

wherein

$${W}_{l , j}^{1}$$

is the jth first type or vector among L first type of vectors for layer l.

$${W}_{j}^{1}$$

is the jth first type of vector among L first type of vectors shared by all layers. β_{l,j} is a weighted coefficient of the jth first type of vector for layer l. That is the precoding matrix of layer l has following format

$${P}_{l} = {\sum }_{j = 0}^{L - 1} {β}_{l , j} {W}_{l , j}^{1} or {P}_{l} = {\sum }_{j = 0}^{L - 1} {β}_{l , j} {W}_{j}^{1} . \qquad ( 37 )$$

In some implementation, the at least two groups of M groups of one precoding vector of one layer have a mathematical relationship to each other can mean that the M groups of the one precoding vector of one layer corresponds to a same set of frequency domain vectors. One frequency domain vector can be referred to or can be named as a second type of vector. Further, the M groups of the one precoding vector corresponds to a same weighted vector of multiple frequency domain vectors of the same set. For example, the precoding matrix (that is a precoding vector) of layer l on frequency domain unit t, t=0,1 . . . . T−1 has one of following format

$${P}_{l , t} = {\sum }_{j = 0}^{L - 1} {W}_{l , j}^{1} {\sum }_{d = 0}^{{D}_{l} - 1} {β}_{l , j , d} {g}_{l , t}^{d} \qquad ( 38 )$$

$${P}_{l , t} = {\sum }_{{j = 0}^{}}^{L - 1} {W}_{j}^{1} {\sum }_{d = 0}^{{D}_{l} - 1} {β}_{l , j , d} {g}_{l , t}^{d} \qquad ( 39 )$$

$${P}_{l , t} = {\sum }_{j = 0}^{L - 1} {W}_{l , j}^{1} {\sum }_{d = 0}^{{D}_{l} - 1} {β}_{l , j , d} {g}_{t}^{d} \qquad ( 40 )$$

$${P}_{l , t} = {\sum }_{j = 0}^{L - 1} {W}_{j}^{1} {\sum }_{d = 0}^{{D}_{l} - 1} {β}_{l , j , d} {g}_{t}^{d} \qquad ( 41 )$$

wherein β_{l,j,d} is a weighted coefficient of the j th first type of vector and dth frequency basis for layer l.

$${g}_{t}^{d}$$

is the t th elements of one frequency domain vector which includes T elements. In some implementation.

$${g}_{t}^{d} = exp ( j 2 π \frac{t * {k}_{d}}{T} ) , {k}_{d} ∈ \{ 0 , 1 , … , T - 1 \} . {g}_{l , t}^{d}$$

is the t th elements of one frequency domain vector which includes T elements and corresponds to layer l. In some implementation.

$${g}_{t}^{l , d} = exp ( j 2 π \frac{t * {k}_{l , d}}{T} ) , {k}_{l , d} ∈ \{ 0 , 1 , … , T - 1 \} .$$

There are T frequency domain units each of which corresponds to one element of the one frequency domain vector. In the case of L=1 in formula (38) to (41), formula (38) to (41) is same as formula (32-2). l^{d}∈{0,1 . . . . T−1} is reported by the UE. In some implementation, the UE reports k_{d} or k_{l,d}. That is the information which indicates the precoding matrix includes at least one of k_{d} or k_{l,d}.

In some implementation, the L first type of vectors

$${W}_{l , j}^{1} ,$$

### J=0,1 . . . . L−1 (or

$${W}_{l , j}^{1} )$$

have a mathematical relationship to each other. For example, the L first type of vectors correspond to same value of qᵢ for each group with index i,i∈{0,1, . . . . M−1} among the M groups of the one precoding vector. In some implementation, one precoding matrix may correspond to L first type of vectors.

In formula (32-2) or (38) to (41) in the case L=1, each layer corresponds to one respective first type of vector. In formula (37) to (41) in the case L is lower than 1, each layer corresponds to more than one first type of vectors. Further, in

$${P}_{l} = {{\sum }_{j = 0}}^{L - 1} {β}_{l , j} {W}_{j}^{1} ,$$

all the R layers correspond to same set of first type of vectors and different layers corresponds to different weighted coefficient of the same set of first type of vectors as shown in formula (39) or (41).

In some implementation, the CSI-RS can be replaced with a measurement reference signal. That is the CSI-RS can be replaced with another measurement reference signal with a name which is not CSI-RS.

In some implementation, each precoding vector of one layer can be based on one or more first type of vectors. Further each precoding vector of one layer can be based on one set of frequency domain vectors. Each first type of vector includes M groups of elements. The M groups of each precoding vector are correlated to each other can mean that M groups of each of the one or more first type of vectors are correlated to each other.

In some implementation, the first type of vector can be named as one of a spatial domain vector, a spatial domain vector in horizontal direction, or a spatial domain vector in vertical direction. Each elements of the first type of vector corresponds to one or more measurement antenna ports. For example, if the elements of the first type of vector is determined by one of formula (4) to (6), then the first type of vector can be named a spatial domain vector. The spatial domain vector is a two dimensions including horizontal direction and vertical direction. Each element of the spatial domain corresponds to one or two measurement reference signal antenna ports. The two measurement reference signal antenna ports corresponds to two polarization antenna port. If the elements of the first type of vector is determined by formula (2) or (3), then the first type of vector can be named a horizontal spatial domain vector or a vertical spatial domain vector. Each element of the spatial domain corresponds to one or more measurement reference signal antenna ports. The more measurement reference signal antenna ports corresponds to one horizontal direction antenna port and more vertical direction antenna ports for each polarization, or corresponds to one vertical direction antenna port and more horizontal direction antenna ports for each polarization.

### II. Example Embodiment 2

In a wireless communication system that includes a communication between a user equipment (UE) and a base station or includes a communication between the UE and the another UE, the UE receives channel state information-reference signal (CSI-RS) from a base station (or the another UE). The UE determines a precoding matrix based on the measurements performed on the received CSI-RS. Each column of the precoding matrix includes N elements. The N elements may include M groups of elements. Each column may correspond to one layer of R layers. Different groups of the M groups may include different elements from the N elements. Each of the M groups of elements may include at least two continuous elements of the N elements. Each column of the precoding matrix can be named as a precoding vector. The M groups of one precoding vector may be correlated to each other. The one precoding vector can be any one of the R precoding vector of the precoding matrix.

The M groups of one precoding vector may be correlated to each other means that each of the M groups of the one precoding vector is based on a respective set of sub vectors and a set of coefficients. The M groups of the one precoding vector corresponds to M sets of sub vectors. Each group of the M groups of the one precoding vector respectively corresponds to a weighted sub vector of one respective set of sub vectors. At least two of the M sets of sub vectors have a mathematical relationship with each other.

In some implementation, the M sets of sub vectors having a mathematical relationship with each other can mean that the M sets of sub vectors includes same sub vectors. That is the M sets of sub vectors are same set.

In some implementation, the M sets of sub vectors having a mathematical relationship to each other can mean that each of the M sets of sub vectors is based on a same first parameter and a respective second parameter. The second parameter for one set with a predefined feature of the M sets of sub vectors satisfies a predefined feature and needed not be reported by the UE.

For example, one group with index i among the M groups of the precoding vector Pₗ has following format

$${P}_{l , i} = {\sum }_{u = 0}^{{Q}_{i} - 1} {β}_{u , i} {V}_{u , i} , {V}_{u , i} = [ \begin{matrix}{v}_{0 , u , i} \\ {v}_{1 , u , i} \\ ⋮ \\ {v}_{{N}_{i} , u , i}\end{matrix} ] , i ∈ \{ 0 , 1 … M - 1 \} , \qquad ( 42 )$$

In some implementation, the M sets of sub vectors having a mathematical relationship to each other can also mean that the M sets of sub vectors corresponds to a same set of frequency domain vectors and each of the M groups corresponds to a respective weighted of frequency domain vectors of the same set of frequency domain vectors.

In some implementation, the M sets of coefficients have no mathematical relationship and are reported by the UE respectively. For example, for each one value i, the Qᵢ value of β_{u,i} comprises the one set of coefficients.

For example, one group with index i among the M groups of the precoding vector Pₗ of layer l on frequency domain unit t, t=0,1 . . . . T−1 has following format

$${P}_{l , i , t} = {\sum }_{u = 0}^{{Q}_{i} - 1} {V}_{u , i} {\sum }_{d = 0}^{D - 1} {β}_{u , i , d} {g}_{l , t}^{d} , i ∈ \{ 0 , 1 … M - 1 \} , \qquad ( 43 )$$

$${P}_{l , i , t} = {\sum }_{u = 0}^{{Q}_{i} - 1} {V}_{u , i} {\sum }_{d = 0}^{D - 1} {β}_{u , i , d} {g}_{t}^{d} , i ∈ \{ 0 , 1 … M - 1 \} , \qquad ( 44 )$$

For example, for each one value i, the Qᵢ*D value of β_{u,i,d} comprises the one set of coefficients. Some of the Qᵢ*D can be default value and does not be reported by the UE.

In some implementation, each sub vector of each of the M sets of sub vectors has format as Vᵢ as shown in formula (1) and is determined according to at least one of formula (2) to (6) except the subscript i is replaced with u,i. For example, V_{u,i} has following format

$${V}_{u , i} = [ \begin{matrix}{v}_{0 , u , i} \\ {v}_{1 , u , i} \\ ⋮ \\ {v}_{{N}_{i} , u , i}\end{matrix} ] , i ∈ \{ 0 , 1 … M - 1 \} , \qquad ( 45 )$$

In some implementation, For example, v_{n,u,i} is determined by at least one of the following formula

$${v}_{n , u , i} = exp ( j 2 π \frac{{m}_{u , i} {O}_{u , i} + {q}_{u , i}}{{N}_{u , i} {O}_{u , i}} n ) , n ∈ \{ 0 , 1 , … {N}_{i} - 1 \} , \\ {m}_{u , i} ∈ \{ 0 , 1 , … {N}_{i} - 1 \} , {q}_{u , i} ∈ \{ 0 , 1 … {O}_{i} - 1 \} ; \qquad ( 46 )$$

$${v}_{n , u , i} = exp ( j 2 π \frac{{m}_{u , i} {O}_{u , i} + {q}_{u , i}}{{N}_{u , i} {O}_{u , i}} n - {b}_{u , i} {n}^{2} ) , n ∈ \{ 0 , 1 , … {N}_{i} - 1 \} , \\ {m}_{u , i} ∈ \{ 0 , 1 , … {N}_{i} - 1 \} , {q}_{u , i} ∈ \{ 0 , 1 … {O}_{i} - 1 \} ; \qquad ( 47 )$$

$${V}_{u , i} = {V}_{1 , u , i} ⊗ {V}_{2 , u , i} = [ \begin{matrix}{v}_{2 , 0 , u , i} {V}_{1 , u , i} \\ {v}_{2 , 1 , u , i} {V}_{1 , u , i} \\ ⋮ \\ {v}_{2 , {N}_{2 , i} , u , i} {V}_{1 , u , i}\end{matrix} ] , wherein$$

$${v}_{j , {n}_{j} , u , i} = exp ( j 2 π \frac{{m}_{j , u , i} {O}_{j , u , i} + {q}_{j , u , i}}{{N}_{j , u , i} {O}_{j , u , i}} {n}_{j} ) , {n}_{j} ∈ \{ 0 , 1 , … {N}_{j , i} - 1 \} , \\ {m}_{j , u , i} ∈ \{ 0 , 1 , … {N}_{j , i} - 1 \} , {q}_{j} ∈ \{ 0 , 1 … {O}_{j , i} - 1 \} j = 1 , 2$$

v_{j,n,u,i} is the value of element with index nⱼ among N_{j,i} elements of V_{j,i} (48):

$${v}_{{n}_{1} * {N}_{1 , i} + {n}_{2} , u , i} = exp ( j 2 π \frac{{m}_{1 , u , i} {O}_{1 , u , i} + {q}_{1 , u , i}}{{N}_{1 , u , i} {O}_{1 , u , i}} {n}_{1} ) * exp ( j 2 π \frac{{m}_{2 , u , i} {O}_{2 , u , i} + {q}_{2 , u , i}}{{N}_{2 , u , i} {O}_{2 , u , i}} {n}_{2} ) , \\ wherein \\ {n}_{1} ∈ \{ 0 , 1 , … {N}_{1 , u , i} - 1 \} , {m}_{1 , u , i} ∈ \{ 0 , 1 , … {N}_{1 , i} - 1 \} , \\ {q}_{1 , u , i} ∈ \{ 0 , 1 … {O}_{1 , i} - 1 \} \qquad ( 49 )$$

$${n}_{2} ∈ \{ 0 , 1 , … {N}_{2 , u , i} - 1 \} , {m}_{2 , u , i} ∈ \{ 0 , 1 , … {N}_{2 , i} - 1 \} , \\ {q}_{2 , u , i} ∈ \{ 0 , 1 … {O}_{2 , i} - 1 \} ; or \\ {V}_{u , i} = {E}_{{n}_{u , i}} \qquad ( 50 )$$

If formula (46) or (47) is used, each of the M sets of sub vectors corresponds to one set of m_{u,i} and one set of q_{u,i}. That is for each one value i, the Qᵢ values of m_{u,i} comprises the one set of m_{u,i} and the Qᵢ values of qui comprises the one set of q_{u,i}. In some implementation, the Qᵢ values of m_{u,i} may include same value and the Qᵢ values of q_{u,i} also may include same value, but the Qᵢ values of m_{u,i}Oᵢ+q_{u,i} are different. That is the number of different values of the Qᵢ of m_{u,i} may be smaller than Qᵢ. The number of different values of the Qᵢ of q_{u,i} may be smaller than Qᵢ, but the number of different value of m_{u,i}Oᵢ+q_{u,i} is Qᵢ. In some implementation, the Q values of q_{u,i} are same for each i. That is for each one value i, the Qᵢ of V_{u,i} corresponds to same q_{u,i}=qᵢ.

In one some implementation, the M sets of m_{u,i} are same set. For example, m_{u,i}=m_{u,j},i,j∈{0,1 . . . . M−1}. For each one value i, the Qᵢ of V_{u,i} corresponds to same q_{u,i}=qᵢ. The M values of qᵢ,i=0,1 . . . . M−1 has mathematical relationship to each other. For example, the M values of qᵢ,i=0,1 . . . . M−1 can be got based on at least one of following format in the case that formula (46) or (47) is used.

Method 1: m_{u,i}=m_{u,j},qᵢ=q+Δ_{2,i}, j∈{0,1, . . . . M−1}. the second parameter includes Δ_{2,i}. In some implementation, Δ_{2,i}_{₀} and does not be reported by the UE.

$${m}_{u , i} = {m}_{u , j} , {q}_{i} = {q}_{i - 1} + {Δ}_{2 , i} , i , j ∈ \{ 0 , 1 , … M - 1 \} . \qquad Method 2$$

For example, the M values of qᵢ,i=0,1 . . . . M−1 can be got based on at least one of following format in the case that formula (48) or (49) is used. If formula (48) or (49) is used, each of the M sets of sub vectors corresponds to one set of m_{j,u,i} and one set of q_{j,u,i} for each j=1,2 That is for each one value i and j, the Qᵢ values of m_{j,u,i} comprises the one set of m_{j,u,i} and the Qᵢ values of q_{j,u,i} comprises the one set of q_{j,u,i}. In some implementation, the Qᵢ values of m_{j,u,i} may includes same value and the Qᵢ values of q_{j,u,i} also include same value, but the Qᵢ values of m_{j,u,i} O_{j,i}+q_{j,u,i} are different. That is the number of different value of q_{j,u,i} may be smaller than Qᵢ the number of different value of m_{j,u,i} may be smaller than Qᵢ, but the number of different values of m_{j,u,i}O_{j,i}+q_{j,u,i} is Qᵢ for Q_{j,i}. In some implementation, the Qᵢ values of q_{j,u,i} are same for each i. That is for each one value i, the Qᵢ of V_{j,u,i} corresponds to same q_{j,u,i}=q_{j,i}.

In one some implementation, for each j, the M sets of m_{j,u,i} are same set. For example, m_{j,u,i}_{₁}=m_{j,u,i}_{₂}, i₁,i₂∈{0,1 . . . . M−1}, j=1,2. For each one value i and j, the Qᵢ of V_{j,u,i} correspond to same q_{j,u,i}=q_{j,i}. For each j, the M values of q_{j,i}=0,1 . . . . M−1 has mathematical relationship to each other. For example, the M values of q_{j,i},i=0,1 . . . . M−1 can be got based on at least one of following format in the case that formula (48) or (49) is used.

Method 1: m_{j,u,i}_{₁}=m_{j,u,i}_{₂},q_{j,i}=qⱼ+Δ_{2,j,i},i₁,i₂∈{0,1, . . . M−1}, j=1,2, the second parameter includes Δ_{2,i}. In some implementation, Δ_{2,i}_{₀}=0 and does not be reported by the UE.

$${m}_{j , u , {i}_{1}} = {m}_{j , u , {i}_{2}} , {q}_{j , i} = {q}_{j , i - 1} + {Δ}_{2 , j , i} , \\ i , {i}_{1} , {i}_{2} ∈ \{ 0 , 1 , … M - 1 \} , j ∈ \{ 1 , 2 \} . \qquad Method 2$$

In some implementation, the one set with the predefined feature of the M sets of sub vectors is based on the first parameter. Each sub vector of each of the remaining sets of sub vectors can be determined by a sub vector of the one set with the predefined feature of the M sets of sub vectors. For example, the one set with the predefined feature of the M sets of sub vectors includes Qᵢ_{₀} sub vectors. Each of the remaining set of the M sets of sub vectors includes up to Qᵢ_{₀} sub vectors. Each sub vector of the remaining set of the M sets of sub vectors is based on one sub vector of the one set with the predefined feature of the M sets of sub vectors and a respective second parameter using above method.

In formula (42)-(44), each set of sub vector for one group of the M groups of each layer are same. That is V_{u,i} is shared by all layers l∈{0,1, . . . , R−1}. The R layers corresponds to same set of sub vectors for each group index i. It is more suitable for the case with large Qᵢ. In some embodiments, each layer can respectively corresponds to one set of sub vector for each group index i. That is V_{u,i} should be replaced with V_{l,u,j}. It is more suitable for the case with small Qᵢ.

In some implementation, the number of sub vectors in different sets of the M sets of sub vectors are same. The subscript of Qᵢ can be ignored.

### III. Example Embodiment 3

In a wireless communication system that includes a user equipment (UE) and a base station (or the another UE), the UE receives channel state information-reference signal (CSI-RS) from a base station (or the another UE). The UE determines a precoding matrix based on the measurements performed on the received CSI-RS. Each column of the precoding matrix includes N elements. The N elements may include M groups of elements. Each column may correspond to one layer of R layers. Different groups of the M groups may include different elements from the N elements. Each of the M groups of elements may include at least two continuous elements of the N elements. In some implementation, the N elements just include elements of the M groups of elements. In another implementation, the N elements include elements in M groups of elements and other elements not in any of the M groups. N is equal to or larger than 1. M is equal to or larger than 1. Each of the M groups respectively corresponds to one set of sub vectors and one set of coefficients. The one set of sub vectors includes one or more sub vectors. The one set of coefficients includes one or more coefficients. Then the M groups of elements corresponds to M sets of sub vectors and M sets of coefficients. Each of the M sets of sub vectors corresponds to one group of the M groups. Each of the M sets of coefficients corresponds to one group of the M groups.

The M groups of elements may have a mathematical relationship to each other, wherein the M groups of elements may have a mathematical relationship to each other includes that at least one of
at least two of the M sets of sub vectors have a mathematical relationship to each other (or are correlated to each other),
at least two sets of the M sets of coefficient have a mathematical relationship to each other, and
at least one set of the M sets of sub vectors and at least one set of M sets of coefficients have a mathematical relationship to each other.

### IV. Example Embodiment 4

The UE receives X CSI-RS resources or other measurement reference signal resources from a base station or another UEs, wherein X is larger than 1. Each of the X CSI-RS resource includes one or more CIS-RS ports. Each of the X CSI-RS resources may be transmitted from different TRPs (transmit and receive point) of the base station or the another UE. The UE determines X PMI (precoding matrix indicator) and same CQI based on the X CSI-RS resources. The X PMI correspond to same RI. Each of the X PMI corresponds to one of the X CSI-RS resources. The same CQI and RI corresponds to all of the X CSI-RS resources.

For example, for calculating the CQI (Channel quantity indicator), the UE assumes one of following transmission scheme

$${Y}_{i} ( s ) = {\sum }_{l = 0}^{R - 1} {W}_{i , l} {x}_{l} ( s ) , l = 0 , 1 … R - 1 \\ {Y}_{i} ( s ) = \frac{1}{{γ}_{l}} {{\sum }_{l = 0}}^{R - 1} {W}_{i , l} {x}_{l} ( s ) , l = 0 , 1 … R - 1 \\ {Y}_{i} ( s ) = [ \begin{matrix}{\sum }_{l = 0}^{R - 1} {W}_{i , l}^{A} {x}_{l} ( s ) \\ {\sum }_{l = 0}^{R - 1} {W}_{i , l}^{B} {x}_{l} ( s )\end{matrix} ] , l = 0 , 1 … R - 1 \\ Y ( s ) = {\sum }_{l = 0}^{R - 1} {W}_{l}^{1} {x}_{l} ( s ) , l = 0 , 1 … R - 1 \qquad ( 31 )$$

wherein i=0,1 . . . . X−1 the Yᵢ(s) correspond to Nᵢ CSI-RS antenna ports of one CSI-RS resource with index i of the X groups on a time frequency resource with index s and W_{i,l} correspond to the precoding matrix with index i among the X PMI of layer l. The Y(s) correspond to all CSI-RS antenna ports across the X CSI-RS resources. Each layer has its respective first type of vector W_{i,1}. xₗ(s) is the lth layer of PDSCH on a time frequency resource with an index s. The X CSI-RS resources corresponds to same layers of data. The same layers of data are shared by the X CSI-RS resources. For example, the one layer is mapped to each CSI-RS port of the X CSI-RS resources.

The X PMIs are included in X PUSCH/PUCCH parts and are reported by the UE to X TRPs respectively. Each of the X PMIs is respectively included in one of X PUSCH/PUCCH parts and is reported by the UE to one of the X TRPs respectively. The X PUSCH/PUCCH parts corresponds to X resources and each of the X PUSCH/PUCCH parts respectively corresponds to one of the X resources. Each of the X resources may include at least one resource of time resource, frequency domain resource, code domain resource and spatial domain resource. For example, the X=2. The first PMI is included in a first PUSCH/PUCCH part and is reported to a first TRP. The second PMI is included in a second PUSCH/PUCCH part and is reported to a second TRP. The two PMI are included in two UCI and coded respectively. Each of the UCI is included in one of the two PUSCH/PUCCH parts.

In some implementation, the same CQI and RI is included in each of the X PUSCH/PUCCH parts.

In some implementation, the same CQI and RI is included only one of the X PUSCH/PUCCH parts.

In some implementation, the same CQI and RI is included one PUSCH/PUCCH part other than the X PUSCH/PUCCH parts.

In some implementation, the X CSI-RS resources correspond to X PMI, X RI and same CQI. Each of the X CSI-RS resources corresponds to one of X PMI and one of the X RI. The X PMI and RI are included in X PUSCH/PUCCH parts. Each of the X PUSCH/PUCCH parts includes one of the X PMI and one of the X RI.

In some implementation, the UE determines a mapping relationship between the X PUSCH/PUCCH parts and the X CSI-RS resources according to received signaling or a rule. Then one PMI or one PMI and one RI of one CSI-RS resource is included in one the X PUSCH/PUCCH parts corresponding to the one CSI-RS resource. The rule includes that the index of one PUSCH/PUCCH part among the X PUSCH/PUCCH parts and the index of the one CSI-RS resource among the X CSI-RS resources is same.

In some implementation, the UE determines a mapping relationship between the X PUSCH/PUCCH parts and the X PMIs according to received signaling or a rule. Then one PMI or one PMI and one RI of one CSI-RS resource is included in one the X PUSCH/PUCCH parts corresponding to the one PMI, or corresponding to the one PMI and one RI. The rule includes that the index of one PUSCH/PUCCH part among the X PUSCH/PUCCH parts and the index of the one PMI (or the one PMI and the one RI) among the X PMIs (or among the X PMI and X RI) is same.

In some implementation, the X PUSCH/PUCCH parts can be replaced with X PUSCHs/PUCCHs. That is there are X PUSCHs/PUCCHs

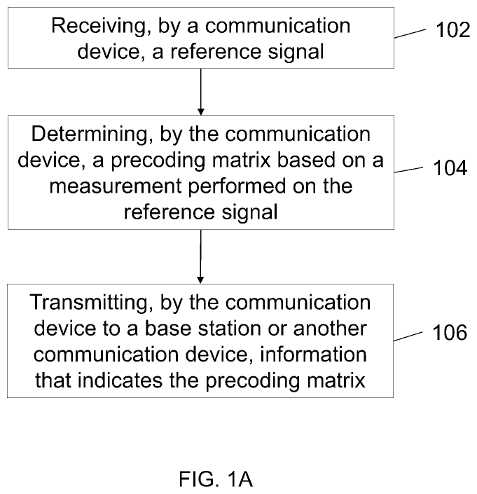

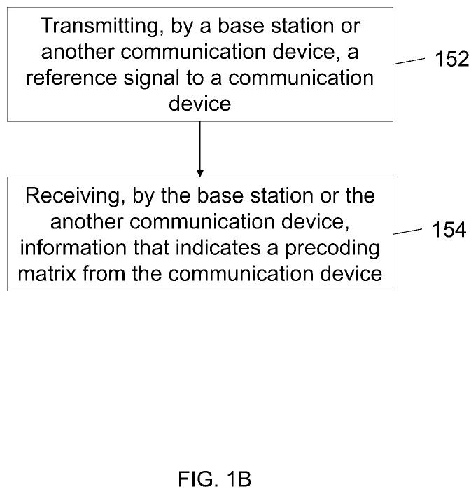

FIG. 1A shows an exemplary flowchart for transmitting information related to a precoding matrix. Operation 102 includes receiving, by a communication device, a reference signal. Operation 104 includes determining, by the communication device, a precoding matrix based on a measurement performed on the reference signal, where the precoding matrix includes one or more columns, where a column of the one or more columns includes N elements, where the N elements includes M groups of elements, where N and M are integers that are greater than or equal to one, where each of the M groups of elements includes at least two continuous elements from the N elements, where different groups of the M groups of elements include different elements from the N elements, and where at least two of the M groups of elements are related to each other. Operation 106 includes transmitting, by the communication device to a base station or another communication device, information that indicates the precoding matrix. The column can be any one of the one or more columns of the precoding matrix, or the column can be partial of the one or more columns of the precoding matrix. In the case that the column can be partial of the one or more columns of the precoding matrix, there is some columns of the precoding matrix is not satisfied the feature of this patient.

FIG. 1B shows an exemplary flowchart for receiving information related to a precoding matrix. Operation 152 includes transmitting, by a base station or another communication device, a reference signal to a communication device. Operation 154 includes receiving, by the base station or the another communication device, information that indicates a precoding matrix from the communication device, where the precoding matrix corresponds to the reference signal, where the precoding matrix includes one or more columns, where a column of the one or more columns includes N elements, where the N elements includes M groups of elements, where N and M are integers that are greater than or equal to one, where each of the M groups of elements includes at least two continuous elements from the N elements, where different groups of the M groups of elements include different elements from the N elements, and where at least two of the M groups of elements are related to each other. The column can be any one of the one or more columns of the precoding matrix, or the column can be partial of the one or more columns of the precoding matrix. In the case that the column can be partial of the one or more columns of the precoding matrix, there is some columns of the precoding matrix is not satisfied the feature of this patient.

In some embodiments, the column is a weighted vector of more than one vector, each of the more than one vector corresponds to M sub vectors and M coefficients, and each of the M sub vectors and each of the M coefficients is associated with elements corresponding to one group of the M groups of elements of each vector. In some embodiments, the M groups of elements is associated with M sub vectors and M coefficients, and each of the M groups of elements corresponds to one sub vector of the M sub vectors and one coefficient of the M coefficients. In some embodiments, the at least two of the M groups of elements are related to each other by having a mathematical relationship between at least two of the M sub vectors. In some embodiments, the at least two of the M groups of elements are related to each other by having a mathematical relationship between at least two of the M coefficients.

In some embodiments, the at least two of the M groups of elements are related to each other by having a mathematical relationship between at least one of the M sub vectors and at least one of the M coefficients. In some embodiments, one sub vector with a first predefined feature from the M sub vectors is determined by a first parameter, and each of one or more remaining sub vectors from the M sub vectors other than the one sub vector is determined by the first parameter and a respective second parameter. In some embodiments, one sub vector with a first predefined feature from the M sub vectors is determined by a first parameter, and a third parameter indicates (1) whether each of one or more remaining sub vectors from the M sub vectors other than the one sub vector is same as the one sub vector, and/or (2) a number of second parameters corresponding to a number of the one or more remaining sub vectors.

In some embodiments, each of the one or more remaining sub vectors is determined by the first parameter and a respective second parameter in response to the third parameter indicating the number of second parameters corresponding to the one or more remaining sub vectors from the M sub vectors other than the one sub vector being larger than zero and/or indicating at least one of the one or more remaining sub vectors from the M sub vectors other than the one sub vector is different from the one sub vector. In some embodiments, the information that indicates the precoding matrix includes at least one of the third parameter or a second parameter. In some embodiments, the second parameter and the third parameter are transmitted by the communication device in different channel state information (CSI) parts. In some embodiments, the third parameter is transmitted in a channel state information (CSI) part I, and the second parameter corresponding to the one or more remaining sub vectors from the M sub vectors other than the one sub vector is transmitted in a CSI part II to the base station in response to a condition being satisfied, or the second parameter is not transmitted in the CSI part II in response to the condition not being satisfied.

In some embodiments, the condition includes the third parameter indicating that: at least one of the one or more remaining sub vectors other than the one sub vector is different from the one sub vector with the first predefined feature, and the number of second parameters corresponding to the one or more remaining sub vectors from the M sub vectors other than the one sub vector is greater than zero. In some embodiments, each of the M sub vectors has only one element with a first value of one and other elements with a second value of zero, and at least two groups of the M groups of elements are related to each other by having a mathematical relationship between positions of the only one element with the first value of one for at least two sub vectors of the M sub vectors. In some embodiments, the at least two sub vectors have continuous indexes among the M sub vectors. In some embodiments, a value for M is determined based on any one or more of: a value of N, a signaling from the base station or the another communication device, or an indication transmitted by the communication device.

In some embodiments, the M groups of elements includes a subset of the N elements. In some embodiments, in a case that M is larger than 1, the N elements is grouped into the M groups of elements. In some embodiments, in a case that M is larger than 1, the N elements is grouped into 2*M groups of elements, and the M groups of elements includes one of following groups: first M groups of the 2*M groups of elements, last M groups of the 2*M groups of elements, groups with odd index among the 2*M groups of elements, or groups with even index among the 2*M groups of elements. In some embodiments, the N elements corresponds to at least N of antenna ports of the reference signal. In some embodiments, the M groups of elements corresponds to a same set of frequency domain vectors, each element of each frequency domain vector corresponds to one frequency domain unit.

In some embodiments, the M groups of elements corresponds to a same weighted vector of multiple frequency domain vectors of the same set of frequency domain vectors. In some embodiments, the more than one vector has a mathematical relationship to each other. In some embodiments, the M groups of elements corresponds to M sets of sub vectors, each of the M groups of elements is based on a respective set of sub vectors and a set of coefficients, at least two of the M groups of elements have a mathematical relationship to each other includes that at least two sets of sub vectors from the M sets of sub vectors have another mathematical relationship with each other. In some embodiments, the M sets of sub vectors includes a same sub vector.

In some embodiments, all of the M sets of sub vector correspond to same first parameter and at least two of the M set of sub vectors corresponds to a respective second parameter. In some embodiments, the first parameter includes one set of m_{j,u,i} for each j=1,2 and the second parameter including q_{j,i}, the n₁*N_{1,i}+n₂ th element of a sub vector with an index u among sub vectors of a set with index i among the M set of sub vectors has following format:

$${v}_{{n}_{1} * {N}_{1 , i} + {n}_{2} , u , i} = exp ( j 2 π \frac{{m}_{1 , u , i} {O}_{1 , u , i} + {q}_{1 , i}}{{N}_{1 , u , i} {O}_{1 , u , i}} {n}_{1} ) exp ( j 2 π \frac{{m}_{2 , u , i} {O}_{2 , u , i} + {q}_{2 , i}}{{N}_{2 , u , i} {O}_{2 , u , i}} {n}_{2} ) , \\ where \\ {n}_{1} ∈ \{ 0 , 1 , … , {N}_{1 , i} \} , {m}_{1 , u , i} ∈ \{ 0 , 1 , … , {N}_{1 , i} \} , {q}_{1 , i} ∈ \{ 0 , 1 , … , {O}_{1 , i} - 1 \} , \\ {n}_{2} ∈ \{ 0 , 1 , … , {N}_{2 , i} \} , {m}_{2 , u , i} ∈ \{ 0 , 1 , … , {N}_{2 , i} \} , {q}_{2 , i} ∈ \{ 0 , 1 , … , {O}_{2 , i} - 1 \} .$$

In some embodiments, each group of the M groups of elements is a weighted of sub vectors from the respective set of sub vectors corresponding to each group. In some embodiments, the M groups of elements corresponds to a same set of frequency domain vectors, each element of each frequency domain vector corresponds to one frequency domain unit. In some embodiments, at least two of the M sub vectors have a mathematical relationship to each other, the M coefficients are not correlated to each other and are reported by the communication device, and the M coefficients and the M sub vectors are not correlated to each other. In some embodiments, at least two of the M sub vectors have a mathematical relationship to each other, at least two of the M coefficients have another mathematical relationship to each other, and the M sub vectors and the M coefficients are not related to each other.

In some embodiments, at least two of the M sub vectors have a mathematical relationship to each other, at least two of the M coefficients have another mathematical relationship to each other, and at least one of the M sub vectors and at least one of the M coefficients are related to each other. In some embodiments, at least two of the M sub vectors have a mathematical relationship to each other by having a sub vector of the M sub vectors being determined by at least one sub vector that neighbors the sub vector. In some embodiments, in a case the M groups of elements includes one of following groups: groups with odd index among the 2*M groups of elements, or groups with even index among the 2*M groups of elements, then groups with odd index among the 2*M groups of elements and groups with even index among the 2*M groups of elements corresponds to same M sub vectors. Each of the 2*M groups corresponds to one sub vector and one coefficient. In some embodiments, in a case the M groups of elements includes one of following groups: first M groups of the 2*M groups of elements, or last M groups of the 2*M groups of elements, then the first M groups of the 2*M groups of elements and the last M groups of the 2*M groups of elements corresponds to same M sub vectors, where each of the 2*M groups corresponds to one sub vector and one coefficient.

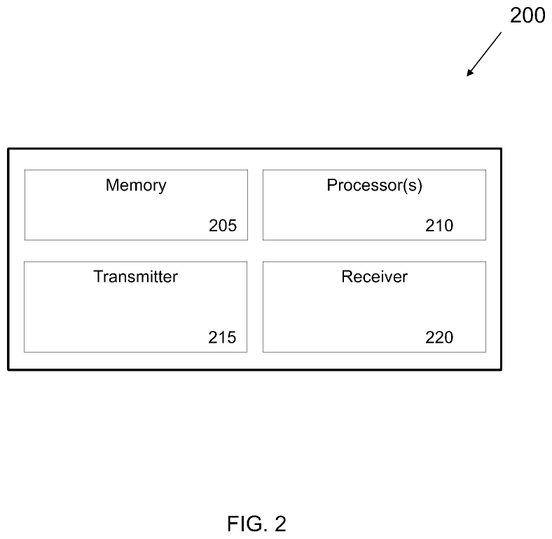

FIG. 2 shows an exemplary block diagram of a hardware platform 200 that may be a part of a network device (e.g., base station) or a communication device (e.g., a user equipment (UE)). The hardware platform 200 includes at least one processor 210 and a memory 205 having instructions stored thereupon. The instructions upon execution by the processor 210 configure the hardware platform 200 to perform the operations described in FIGS. 1A-1B and in the various embodiments described in this patent document. The transmitter 215 transmits or sends information or data to another device. For example, a network device transmitter can send a message to a user equipment. The receiver 220 receives information or data transmitted or sent by another device. For example, a user equipment can receive a message from a network device.

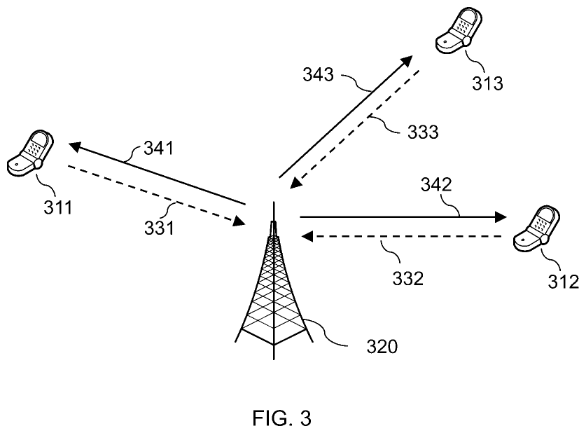

The implementations as discussed above will apply to a wireless communication. FIG. 3 shows an example of a wireless communication system (e.g., a 5G or NR cellular network) that includes a base station (or a user equipment (UE)) 320 and one or more other user equipments (UEs) 311, 312 and 313. In some embodiments, the UEs access the BS (e.g., the network) using a communication link to the network (sometimes called uplink direction, as depicted by dashed arrows 331, 332, 333), which then enables subsequent communication (e.g., shown in the direction from the network to the UEs, sometimes called downlink direction, shown by arrows 341, 342, 343) from the BS to the UEs. In some embodiments, the BS send information to the UEs (sometimes called downlink direction, as depicted by arrows 341, 342, 343), which then enables subsequent communication (e.g., shown in the direction from the UEs to the BS, sometimes called uplink direction, shown by dashed arrows 331, 332, 333) from the UEs to the BS. The UE may be, for example, a smartphone, a tablet, a mobile computer, a machine to machine (M2M) device, an Internet of Things (IoT) device, and so on.

This patent document describes methods for reporting a precoding matrix. In an example method, a relationship between different groups of multiple groups of each column of the precoding matrix can set up. A technical benefit of the disclosed methods is that it can save overhead of reporting the precoding matrix at least because the relationship is set up. It also can reduce the complexity of searching the precoding matrix (e.g., the codebook) at a user equipment (UE) at least because the relationship is set up. The disclosed methods can also provide a solution for the case that a measurement reference signal is a precoded measurement reference signal. This patent especially provides an efficient channel state reporting method for the N is very large system. In the case where at least one of N, N₁ and N₂ is very large, the precoding vector is divided to M groups. Each of group is based on sub vector with less elements than at least one of N, N₁ and

$${N}_{2} \cdot {N}_{1} = {\sum }_{i = 0}^{{M}_{1} - 1} {N}_{1 , i} and {N}_{2} = {\sum }_{i = 0}^{{M}_{2} - 1} {N}_{2 , i} .$$

Then the UE only needs to search in a codebook with less codewords. Further there is a relationship between at least two of the M groups of elements. Then the overhead for reporting the precoding matrix and the complicity of searching the codeword of the precoding matrix among the codebook is reduced efficiently.

In this document the term “exemplary” is used to mean “an example of” and, unless otherwise stated, does not imply an ideal or a preferred embodiment.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

1. A wireless communication method, comprising:
receiving, by a communication device, a reference signal;
determining, by the communication device, a precoding matrix based on a measurement performed on the reference signal,
wherein the precoding matrix includes one or more columns,
wherein a column of the one or more columns includes N elements,
wherein the N elements includes M groups of elements,
wherein N and M are integers that are greater than or equal to one,
wherein each of the M groups of elements includes at least two continuous elements from the N elements,
wherein different groups of the M groups of elements include different elements from the N elements, and
wherein at least two of the M groups of elements are related to each other; and
transmitting, by the communication device to a base station or another communication device, information that indicates the precoding matrix.

2. (canceled)

3. The method of claim 1,
wherein the column is a weighted vector of more than one vector,
wherein each of the more than one vector corresponds to M sub vectors and M coefficients, and
wherein each of the M sub vectors and each of the M coefficients is associated with elements corresponding to one group of the M groups of elements of each vector.

4. The method of claim 1,
wherein the M groups of elements is associated with M sub vectors and M coefficients, and
wherein each of the M groups of elements corresponds to one sub vector of the M sub vectors and one coefficient of the M coefficients.

5. The method of claim 3, wherein the at least two of the M groups of elements are related to each other by having a mathematical relationship between at least two of the M sub vectors.

6. The method of claim 3, wherein the at least two of the M groups of elements are related to each other by having a mathematical relationship between at least two of the M coefficients.

7. The method of claim 3, wherein the at least two of the M groups of elements are related to each other by having a mathematical relationship between at least one of the M sub vectors and at least one of the M coefficients.

8. The method of claim 5,
wherein one sub vector with a first predefined feature from the M sub vectors is determined by a first parameter, and
wherein each of one or more remaining sub vectors from the M sub vectors other than the one sub vector is determined by the first parameter and a respective second parameter, or
wherein a third parameter indicates (1) whether each of one or more remaining sub vectors from the M sub vectors other than the one sub vector is same as the one sub vector, and/or (2) a number of second parameters corresponding to a number of the one or more remaining sub vectors.

9-14. (canceled)

15. The method of claim 1,
wherein each of the M sub vectors has only one element with a first value of one and other elements with a second value of zero, and
wherein at least two groups of the M groups of elements are related to each other by having a mathematical relationship between positions of the only one element with the first value of one for at least two sub vectors of the M sub vectors.

16. (canceled)

17. The method of claim 1, wherein a value for M is determined based on any one or more of: a value of N, a signaling from the base station or the another communication device, or an indication transmitted by the communication device.

18-19. (canceled)

20. The method of claim 1, wherein in a case that M is larger than 1,
the N elements is grouped into 2*M groups of elements, and
the M groups of elements includes one of following groups:
first M groups of the 2*M groups of elements,
last M groups of the 2*M groups of elements,
groups with odd index among the 2*M groups of elements, or
groups with even index among the 2*M groups of elements.

21. (canceled)

22. The method of claim 1, wherein the M groups of elements corresponds to a same set of frequency domain vectors, wherein each element of each frequency domain vector corresponds to one frequency domain unit, and
wherein the M groups of elements corresponds to a same weighted vector of multiple frequency domain vectors of the same set of frequency domain vectors.

23-24. (canceled)

25. The method of claim 1,
wherein the M groups of elements corresponds to M sets of sub vectors,
wherein each of the M groups of elements is based on a respective set of sub vectors and a set of coefficients,
wherein at least two of the M groups of elements have a mathematical relationship to each other includes that at least two sets of sub vectors from the M sets of sub vectors have another mathematical relationship with each other.

26. The method of claim 25, wherein the M sets of sub vectors includes a same sub vector.

27. The method of claim 25, wherein all of the M sets of sub vector correspond to same first parameter and at least two of the M set of sub vectors corresponds to a respective second parameter.

28-36. (canceled)

37. An apparatus for wireless communication comprising a processor,
configured to implement the method recited in claim 1.

38. (canceled)

39. A wireless communication method, comprising:
transmitting, by a base station or another communication device, a reference signal to a communication device; and
receiving, by the base station or the another communication device, information that indicates a precoding matrix from the communication device,
wherein the precoding matrix corresponds to the reference signal,
wherein the precoding matrix includes one or more columns,
wherein a column of the one or more columns includes N elements,
wherein the N elements includes M groups of elements,
wherein N and M are integers that are greater than or equal to one,
wherein each of the M groups of elements includes at least two continuous elements from the N elements,
wherein different groups of the M groups of elements include different elements from the N elements, and
wherein at least two of the M groups of elements are related to each other.

40. The method of claim 39,
wherein the column is a weighted vector of more than one vector,
wherein each of the more than one vector corresponds to M sub vectors and M coefficients, and
wherein each of the M sub vectors and each of the M coefficients is associated with elements corresponding to one group of the M groups of elements of each vector.

41. The method of claim 39,
wherein the M groups of elements is associated with M sub vectors and M coefficients, and
wherein each of the M groups of elements corresponds to one sub vector of the M sub vectors and one coefficient of the M coefficients.

42. The method of claim 40, wherein the at least two of the M groups of elements are related to each other by having a mathematical relationship between at least two of the M sub vectors; or
wherein the at least two of the M groups of elements are related to each other by having a mathematical relationship between at least two of the M coefficients; or
wherein the at least two of the M groups of elements are related to each other by having a mathematical relationship between at least one of the M sub vectors and at least one of the M coefficients.

43. An apparatus for wireless communication comprising a processor, configured to implement the method recited in claim 39.
